(19) United States
(12) Patent Application Publication
(10) Pub. No.: US 2007/0174823 A1
(43) Pub. Date: Jul. 26, 2007

(54) Compile-time interpretable code error detection

(75) Inventors: Jeffrey P. Snover, Woodinville, WA (US); Jeffrey Dick Jones, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/339,365

(22) Filed: Jan. 25, 2006

(51) Int. Cl. G06F 9/45; G06F 9/44

(52) U.S. Cl. 717/139; 717/124

(57) ABSTRACT

The facilitation of error detection in interpretable code prior to run-time of the interpretable code. Upon accessing an interpretable command, corresponding structural rules for the interpretable command are used to automatically formulate a compilable linkable representation of the interpretable command that conforms to the construction rules. Source code may then be formulated that, when compiled, is linked to the compilable linkable representation of the interpretable command. If there are compilation errors, those errors may be discovered at compilation-time, rather than waiting until run-time. On the other hand, if there are no compilation errors, the compiled object may be executed to thereby invoke the interpretable command.

### BACKGROUND

### Background and Relevant Art

Computing systems have revolutionized the way we work and play. Computing systems come in a wide variety of forms including laptop computers, desktop computers, personal digital assistants, telephones, and even devices that have not been conventionally associated with computing systems such as, for example, refrigerators and automobiles. Computing systems may even comprise a number of constituent computing systems interconnected via a network. Thus, some computing systems may be small enough to fit in the palm of the hand, while others are spread over much of the globe.

Regardless of their physical form, computing systems are composed of hardware and software. The hardware includes most fundamentally at least one processor and memory. The software includes instructions that may be embodied in the memory or in storage, and that can be accessed and executed by the processor(s) to direct the overall functionality of the computing system. Thus, software is critical in enabling and directing computing system functionality.

Software is often initially drafted using “source code” which represents the desired functionality of the software using a programming language that is more human readable. At some point prior to execution of the software, the software is coverted into a form that is readable by the processor(s) of the computing system. there are two fundamental processes that may cause such a conversion; namely, compilation and interpretation.

In compilation or interpretation, a compiler (in the case of compilation) or an interpreter (in the case of interpretation) accesses source code drafted in accordance with a programming language. If the source code complies with the programming language and includes no obvious functional errors, the compiler or interpreter generates executable code that may be executed by the computing system. If the source code includes errors, the compilation and interpretation functions often generate error messages allowing the author to make corrections to the source code. Compilation occurs often well before the executable code is to be run. The compiler simply generates an executable file, which may later be executed at some appropriate time. Interpretation, on the other hand, occurs at run-time, just prior to the executable code being generated.

Sometimes, interpretable code is embedded within compilable code. In that case, the compilable code is compiled into an executable file, but the interpretable code is not interpreted until run-time. Thus, if there are errors in the interpretable code, the functionality of the entire code may be at risk.

### BRIEF SUMMARY

Aspects of embodiments of the present invention relate to the facilitation of error detection in interpretable code prior to run-time of the interpretable code. Upon accessing an interpretable command, corresponding construction rules for the interpretable command are used to formulate a compilable linkable representation of the interpretable command that conforms to the construction rules. Source code may be generated that creates and populates an object that links to the compilable linkable representation upon compilation. If compilation errors occur, those errors may be fixed well in advance of run-time if desired. If there are no compilation errors, the object may be executed to thereby invoke the interpretable command. Thus, rather than waiting until run-time to determine if the invocation of the interpretable command will have errors, the corresponding compilable code may be compiled to discover any errors in advance of run-time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a suitable computing environment in which the principles of the present invention may be employed;

FIG. 2 illustrates an environment in which a compilation code generator formulates a compilable linkable representation of interpretable code based on construction rules for the interpretable code in accordance with one aspect of the principles of the present invention, and in that compilable linkable representation is used to identify any errors in the invocation of a compilable representation of an interpretable command at compile-time, rather than necessarily at run-time; and

FIG. 3 illustrates a flowchart of a method for facilitating error detection in interpretable code prior to run-time of the interpretable code in accordance with one aspect of the present invention.

### DETAILED DESCRIPTION

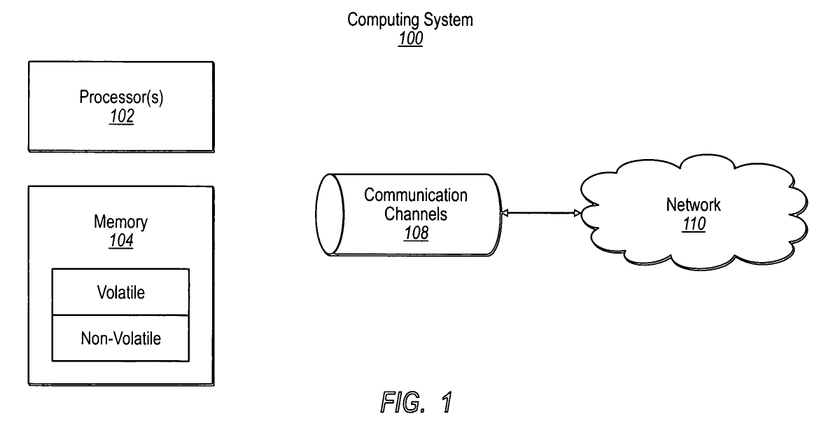

The present invention extends to the facilitation of error detection in the invocation of interpretable code prior to run-time of the interpretable code. First, an example computing system in which the principles of the present invention may operate will be described with respect to FIG. 1. Then, the principles of the present invention will be described in further detail with respect to the subsequent Figures. The embodiments of the present invention may comprise a special purpose or general-purpose computer including various computer hardware, as discussed in greater detail below.

FIG. 1 shows a schematic diagram of an example computing system 100 that may be used to implement features of the present invention. The described computing system is only one example of such a suitable computing system and is not intended to suggest any limitation as to the scope of use or functionality of the invention. Neither should the invention be interpreted as having any dependency or requirement relating to any one or combination of components illustrated in FIG. 1.

Computing systems are now increasingly taking a wide variety of forms. Computing systems may, for example, be handheld devices, appliances, laptop computers, desktop computers, mainframes, or distributed computing systems. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

Referring to FIG. 1, in its most basic configuration, a computing system 100 typically includes at least one processing unit 102 and memory 104. The memory 104 may be volatile, non-volatile, or some combination of the two, and represents one or more physical computer-readable media. An example of volatile memory includes Random Access Memory (RAM). Examples of non-volatile memory include Read Only Memory (ROM), flash memory, or the like. The term “memory” may also be used herein to refer to non-volatile mass storage. Such storage may be removable or non-removable, and may include (but is not limited to) PCMCIA cards, magnetic and optical disks, magnetic tape, and the like.

As used herein, the term “module” or “component” can refer to software objects or routines that execute on the computing system. The different components, modules, engines, and services described herein may be implemented as objects or processes that execute on the computing system (e.g., as separate threads) as part of a protocol. While the system and methods described herein may be implemented in software, implementations in hardware, and in combinations of software and hardware are also possible and contemplated.

In the description that follows, embodiments of the invention are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other computing systems over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

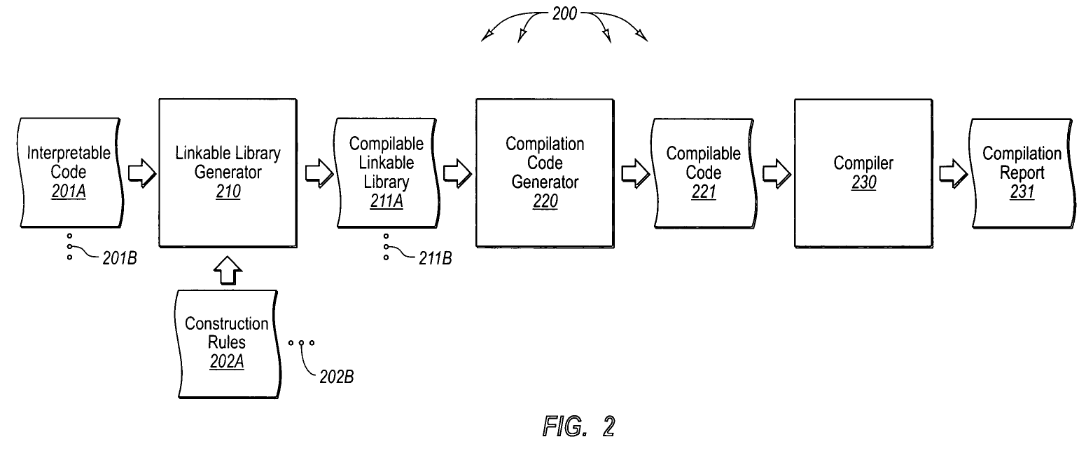

FIG. 2 illustrates an environment 200 in which the principles of the present invention may operate. The environment 200 may, but need not, be implemented within the computing system 100 of FIG. 1. If so, the environment 200 may include objects and data structures instantiated in system memory and/or may be functional computer-executable instructions that are in storage.

A linkable library generator 210 may be hardware, software, or a combination of hardware and software. The linkable library generator 210 is a component that accesses interpretable code 201A, and formulates a compilable linkable representation of the interpretable code 211A (see compilable linkable library 211A) using the associated construction rules 202A for that interpretable code 201A. In this description and in the claims, a “linkable library” is any group of one or more representations of class definitions to which objects may be linked during compilation. The linkable library generator 210 may formulate the compilable linkable library 211A automatically, without human intervention, or may allow user intervention to allow a human to participate in the formulation process. The linkable library generator 201 may comprise one or more modules and/or may include portions of modules that are not involved with the linkable library generation.

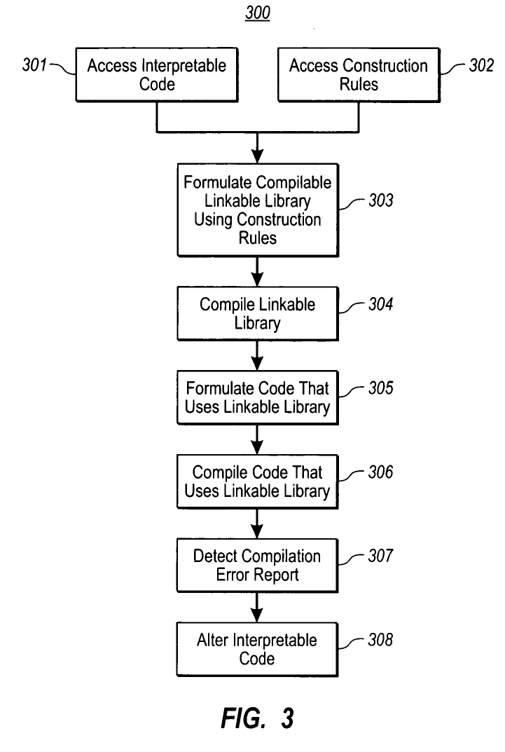

FIG. 3 illustrates a flowchart of a method 300 for facilitating error detection in interpretable code prior to run-time of the interpretable code in accordance with one aspect of the principles of the present invention. As the method 300 may be performed in the environment 200, the method 300 of FIG. 3 will be described with frequent reference to the environment 200 of FIG. 2.

First, the linkable library generator 210 accesses an interpretable command (act 301). Referring to FIG. 2, the interpretable command may be represented in interpretable code 201A. The interpretable code may be accessed over a network, from local storage, from system memory, or from any combination thereof. The interpretable code may have been constructed recently, or in the more distant past, and may be authored by a human, or generated automatically by a computing system.

Two examples of interpretable commands will now be given, and will be used throughout this description in order to clarify the broader principles of the present invention. In the first example, referring to hereinafter as the “first example”, the interpretable command takes the following form:
Set-location-path “c:\windows”

This interpretable command may be permissible using a command line tool. The command sets a current location in navigating a directory structure. This command would set the current directory in the c:\windows directory. Instead of being entered into a command line tool, however, the interpretable command may be entered programmatically as a parameter into compilable code. For instance, the Set-location command may be embedded programmatically into a ShellExecute command a follows:
ShellExecute(“Set-location-path ‘c:\windows’”)

As a second example referred to hereinafter as the “second example”, consider the following interpretable code represented as a command line entry:
Get-item-path “c:\windows”

The command gets a listing of all files at the location specified in the path property; in this case, “c:\windows”. Once again, instead of being entered into a command line tool, however, the interpretable command may be entered programmatically as a parameter into compilable code as follows:
ShellExecute(“Get-item-path ‘c:\windows’”)

Conventionally, whether the interpretable command is entered into a command line tool for immediate execution, or whether the interpretable command is embedded programmatically within other source code (e.g., ShellExecute(“. . . ”)), the structure of the interpretable code itself is not evaluated until run-time, just prior to when the interpretable code is executed. Such is the nature of interpretable code. Accordingly, if there were any errors in the interpretable code, they would not be discovered until run-time, even if the interpretable code was embedded in other compilable source code.

In accordance with the principles of the present invention, a compilable linkable representation of the interpretable code itself is formulated. Source code may then be formulated that, when compiled, creates and populates an object that is based on the compilable linkable representation. The compiled and linked object, when executed, invokes the corresponding interpretable comment. If the compilation of the source code fails, then there are more likely errors in the source code that invokes the interpretable command. Those errors may thus be fixed well prior to run-time if desired.

Referring back to FIGS. 2 and 3, in addition to accessing the interpretable command 201A (act 301), the compilation code generator 210 also accesses construction rules corresponding to the interpretable command (act 302). For instance, construction rules 202A may correspond to the interpretable command 201A. Other construction rules 202B may correspond to other interpretable commands 201B.

For instance, for the first example of “Set-location-path ‘c:\windows’”, the construction rules for the category of commands for “Set-location” may be accessed. Those construction rules may specify the title of the command (e.g., “Set-location”), as well as list the appropriate titles for any properties of the command (e.g., in this case “path”), perhaps whether or not the properties are mandatory or optional, what would be acceptable value types and/or values (e.g., a text string would be an acceptable value type for the property “path”), and any other construction rules. The construction rules may be represented in human-readable form in which case the construction rules may be evaluated by a human. Alternatively, the construction rules may be represented in computer-readable form such as, for example, in an extensible Markup Language (XML) document that conforms to a schema understood by the computing system.

Similarly, for the second example of “Get-item-path ‘c:\windows’”, the construction rules for the category of commands for “Get-item” may be accessed. Those construction rules may specify the title of the command (e.g., “Get-item”), as well as list the appropriate titles for any properties of the command (e.g., in this case, “path”), perhaps whether or not the properties are mandatory of optional, what would be acceptable value types and/or values (e.g., a text string would be an acceptable value type for the property “path”), and so forth. Once again, the construction rules may be interpreted by a human, and/or may be interpreted by a computer.

Referring back to FIGS. 2 and 3, the linkable library generator then uses the constructions rules to formulate a compilable linkable representation of the interpretable command that conforms to the construction rules (act 303). For instance, in FIG. 2, the linkable library generator 210 generates compilable linkable library 211A. This may be performed in a variety of ways. For instance, in a manual method, a human author may evaluate the construction rules and formulate a compilable linkable representation of the interpretation code using the linkable library generator 210 as an authoring tool. In an automated method, the linkable library generator 210 itself may perform the evaluation and authoring without human intervention.

Once completed, the compilable linkable representation is structured in accordance with the structural rules associated with the interpretable command. Referring to FIG. 3, the compilable linkable representation of the interpretable code may then be compiled (act 304) even if it will be some time before the interpretable code is executed.

At any point prior to run-time, code (e.g., source code) may be formulated (act 305) that, when compiled, (act 306), formulates and populates an object that is based on and links to the compilable linkable representation of the interpretable code. For instance, if the compilable linkable representation was a class definition, then the source code may direct the formulation and population of an object that is an instance of the class defined by the class definition. Referring to FIG. 2, the compilation code generator 220 generates compilable code 221, which is then compiled using compiler 230 to generate a compilation report 231. The source code may be generated automatically by a computer, or may be generated in response to user input.

If a compilation error is not detected as a result of the compilation, then the interpretation code is more likely structurally sound and would less likely result in a run-time error when executed. Thus, at any point thereafter, the object may be executed to thereby invoke the interpretable command. If a compilation error is detected as a result of the compilation (act 307), then the source code that created the object that invokes the interpretable command may be altered to correct the error (act 308). Accordingly, rather than wait until run-time to detect and correct an error in the or not embedded within compilable code, any errors may be detected well in advance of run-time. The method 300 of FIG. 3 may be performed for multiple commands, multiple construction rules, with multiple compilable linkable representations of interpretable code as represented by the ellipses 201B, 202B and 211B.

As a specific example in which the compilable linkable representation of the interpretable command is a class definition, the parameters of a class definition may be generated by taking the parameters of the interpretable command and setting properties of the same name in the class definition. An invoke method may be added to the class definition that takes the properties of the class that have been set and runs the command using the values of the properties as arguments to the class' respective parameters. A class may be instantiated to form an object, sets the properties of the parameters to values that correspond to the values provided in the interpretable command. Then, the invoke method may be called.

Referring now to the first example in which the interpretable command “Set-location-path ‘c:\windows’” is provided to the compilable code generator 210. The compilable code generator may generate the following class as represented using C# skeletal code:

```
Public class SetLocationCommand
{
    Public string Path
    { get { ...}
        set {
            if (!IsValidPath(value))
            {  throw ArgumentException
            }
            {
            Else {...}
            }
    }
    Public object Invoke( ) { ...}
}
```

The source code that generates the object that, when executed invokes the interpretable “Set-location-path ‘c:\windows’” command may appear as follows in the first example:

SetLocationCommand command = new SetLocationCommand( );
command.path = “c:\windows”;
object result = command.Invoke( );

The invoke method, when called, executes the interpretable command from which the compilable linkable representation was generated, and returns the results, if any.

If the source code tries to set a parameter that does not exist, there will be a compile-time error. For example, the second line below would cause a failure when the compiler is run since “FullName” is not a defined property of the class “SetLocationCommand”.

SetLocationCommand command = new SetLocationCommand( );
command.FullName = “c:\windows”;
object result = command.Invoke( );

In the second example, the interpretable command “Get-item-path ‘c:\windows’” is converted into the following class as represented by pseudo code:

```
Class GetItemCommand
{
    String Path {...}
    IEnumerate Invoke {...}
}
```

Source code may be generated that, when compiled and executed, instantiates an object instance of the class. For instance, the source code may appear as follows:

GetItemCommand = newGetItemCommand( );
GetItemCommand.Path = “c:\windows”;
GetItemCommand.Invoke;

Upon compilation, one would know that the corresponding object would more likely successfully execute the interpretable command associated with the command “Get-item-path ‘c:\windows’” at run-time, since the source code compiled and linked to a class which defines the structure of the associated interpretable command. Now suppose that the drafter had instead drafted the following source code:

GetItemCommand = newGetItemCommand( );
GetItemCommand.ath = “c:\windows”;
GetItemCommand.Invoke;

Here, the user simply missed typing “p” for “path”. When compiling this source code, the compiler will recognize that the “GetltemCommand” class does not have an “ath” property, thereby failing compilation. Accordingly, after compile-time, the error in the source code may be corrected well in advance of run-time.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for facilitating error detection in interpretable code prior to run-time of the interpretable code, the method comprising the following:
an act of accessing an interpretable command;
an act of accessing construction rules corresponding to the interpretable command; and
an act of using the construction rules to formulate a compilable linkable representation of the interpretable command that conforms to the construction rules.

2. A computer-implemented method in accordance with claim 1, wherein the compilable linkable representation of the interpretable command comprising a class definition for an object that conforms to the construction rules.

3. A computer-implemented method in accordance with claim 1, further comprising the following:
an act of formulating source code that, when compiled, creates and populates an object that is linked to the compilable linkable representation of the command.

4. A computer-implemented method in accordance with claim 3, further comprising:
an act of compiling the source code to thereby create and populate an object that is linked to the compilable linkable representation of the command.

5. A computer-implemented method in accordance with claim 4, further comprising:
an act of detecting a compilation error report as a result of the act of compiling.

6. A computer-implemented method in accordance with claim 5, further comprising:
an act of altering the interpretable command as a result of the compilation error report.

7. A computer-implemented method in accordance with claim 1, wherein the construction rules define structural rules for a category of rules that include the command.

8. A computer-implemented method in accordance with claim 7, wherein the construction rules are first construction rules, the category of rules is a first category of rules, and the command is a first command, the method further comprising the following:
an act of accessing a second interpretable command that is in a second category of rules that is different than the first category of rules;
an act of accessing second construction rules corresponding to the second interpretable command; and
an act of using the second construction rules to formulate a second compilable linkable representation of the second interpretable command that conforms to the second construction rules.

9. A computer-implemented method in accordance with claim 8, wherein the second compilable linkable representation of the second interpretable command comprises a second class definition for a second object that conforms to the second construction rules.

10. A computer-implemented method in accordance with claim 8, further comprising:
an act of formulating source code that, when compiled, creates and populates an object that is linked to the second compilable linkable representation of the command.

11. A computer program product comprising one or more computer-readable media having thereon computer-executable instructions that are structured such that, when executed by one or more processors of a computing system, the one or more processors cause the computing system to perform a method for facilitating error detection in interpretable code prior to run-time of the interpretable code, the method comprising the following:
accessing an interpretable command and construction rules corresponding to the interpretable command; and
formulate a compilable linkable representation of the interpretable command using the construction rules.

12. A computer program product in accordance with claim 11, wherein the one or more computer-readable media is physical system memory and/or physical storage media.

13. A computer program product in accordance with claim 11, wherein the one or more computer-readable media is a removable storage media.

14. A computer program product in accordance with claim 11, wherein the compilable linkable representation of the interpretable command comprising a class definition for an object that conforms to the construction rules.

15. A computer program product in accordance with claim 11, wherein the compilable linkable representation of the interpretable command comprises source code that is configured to formulate and populate an object that is derived from the class definition.

16. A computer program product in accordance with claim 15, the method further comprising:
an act of formulating source code that, when compiled, creates and populates an object that is linked to the compilable linkable representation of the command.

17. A computer-program product in accordance with claim 16, wherein the construction rules define structural rules for a category of rules that include the command.

18. A computing system comprising:
one or more processors;
one or more physical computer-readable media having thereon computer-executable instructions that are structured such that, when executed by the one or more processors of a computing system, the one or more processors cause the computing system to formulate a compilable linkable representation of an interpretable command using construction rules upon accessing the interpretable command and the construction rules.

19. A computing system in accordance with claim 18, wherein the compilable linkable representation of the interpretable command comprises a class definition for an object that conforms to the construction rules.

20. A computing system in accordance with claim 18, wherein the compilable linkable representation of the interpretable command may be used to formulate source code that, when compiled, is configured to formulate and populate an object that is linked to the class definition.
